(19) United States
(12) Patent Application Publication
(10) Pub. No.: US 2006/0064740 A1
(43) Pub. Date: Mar. 23, 2006

(54) Network threat risk assessment tool

(75) Inventors: Jeremy Donald Kelley, Leander, TX (US); Jeffrey Scott Lahann, Erie, CO (US); David Hugh Mackey II, Longmont, CO (US)

Correspondence Address: IBM CORPORATION (SYL-END);C/O SYNNESTVEDT & LECHNER LLP, 1101 MARKET STREET, SUITE 2600, PHILADELPHIA, PA, 19107, US

(73) Assignee: International Business Machines Corporation, Armonk, NY (US)

(21) Appl. No.: 10/947,575

(22) Filed: Sep. 22, 2004

(51) Int. Cl. H04L 9/32

(52) U.S. Cl. 726/3

(57) ABSTRACT

A method, system and computer program product is disclosed that provides timely, accurate and summarized information about possible threats to information technology environments. It is a tool that looks at multiple aspects of an IT threat, including both specific (traditional) IT threats and general (non-traditional) IT threats, and rates each threat's overall potential to do harm. A matrix is created that identifies a “threat score” to allow prioritization and reaction to the threats. The matrix takes both traditional IT threats and non-traditional IT threats and normalizes them on the same scale, giving users of the matrix the ability to understand the risks of both.

### BACKGROUND OF THE INVENTION

1. Field of the Invention

The present invention relates to network security and, more particularly, to tools for identifying threats to network security.

2. Description of the Related Art

Networks are a critical element of almost every business today, whether large or small. Businesses rely upon internal networks, wide area networks, and public networks such as the Internet for communication, to operate the business, provide services, and sell products. With networks serving such a vital business role, threats to a network that might detrimentally affect its operation must be detected as quickly as possible so that preventive and/or corrective measures can be promptly taken. Lost network time translates to lost profits for businesses and, in the case of an online business, loss of a network can completely shut down operations.

In view of the significant problems resulting from network failures and network problems, it is not surprising that efforts have been made to detect network threats and correct problems caused when the threats are realized. These efforts typically focus on “traditional” threats such as software vulnerabilities, hacker attacks, and malware outbreaks (i.e., worms, viruses, Trojan horses, etc.). A traditional IT threat as used herein is a deliberate attack that targets the internal operating systems of computer systems or networks. Known systems such as virus checkers detect the occurrence of a known virus, notify a user of the system of the existence of the virus, and, in some cases, quarantine or destroy the virus, all automatically. Firewalls have been developed to impede the ability of a hacker to gain access to the network.

These threat detection and notification services of the prior art focus on Information Technology (IT) aspects of the threats (i.e., threats that are exclusively in the realm of IT) such as worms and hackers and then provide information (statistics, threat ratings, etc.). As such, the statistics analyzed and overall rating system used to rate these threats are also directed to IT-centric threats only. For example, Symantec rates viruses using the parameters “wild”, “damage”, and “distribution” defined by Symantec as follows:

Wild—The wild component measures the extent to which a virus is already spreading among computer users. This measurement includes the number of infected independent sites and computers, the geographic distribution of infection, the ability of current technology to combat the threat, and the complexity of the virus.

Damage—The damage component measures the amount of harm that a given threat might inflict. This measurement includes triggered events, clogging email servers, deleting or modifying files, releasing confidential information, performance degradation, errors in the virus code, compromising security settings, and the ease with which the damage may be fixed.

Distribution—This component measures how quickly a threat is able to spread.

However, the various criteria are applied to one specific category of IT threat (e.g., a virus), that is, they fail to consider information regarding other possible/probable elements that are “non-traditional” threats in the realm of IT.

Non-traditional threats as used herein are threats that do not directly target computer systems and/or networks or that do not target anything at all, but that still pose a threat to proper operation of the computer system or network. Examples of non-traditional threats in the context of the present invention include, but are not limited to, weather-related problems (flooding, electrical storms, severe temperatures); atmospheric conditions affecting electrical devices such as sunspots and solar flares; terrorist attacks on facilities in which networks are physically located or on electrical sources powering the networks, and the like. For example, a hurricane or other weather-related event that could pose a great danger to the IT system of an organization (but which is not a specific IT threat) is not even considered in prior art threat analysis systems.

Accordingly, it would be desirable to have a threat identification system that considers not only IT-specific (traditional) threats, but also other more general (non-traditional), but seriously problematic, threats that may detrimentally impact an IT system.

### SUMMARY OF THE INVENTION

The present invention is a method and system that provides timely, accurate and summarized information about possible threats to information technology environments. It is a tool that looks at multiple aspects of an IT threat, including both specific (traditional) IT threats and general (non-traditional) IT threats, and rates each threat's overall potential to do harm. A matrix is created that identifies a “threat score” to allow prioritization and reaction to the threats. The matrix takes both traditional IT threats and non-traditional IT threats and normalizes them on the same scale, giving users of the matrix the ability to understand the risks of both.

### BRIEF DESCRIPTION OF THE DRAWINGS

FIG. 1 is a block diagram illustrating a network environment and the various threats to which it is subjected;

FIG. 2 is a block diagram illustrating a system to practice the method of the present invention; and

FIG. 3 is an example of a threat matrix used to develop threat ratings.

### DETAILED DESCRIPTION OF THE PREFERRED EMBODIMENTS

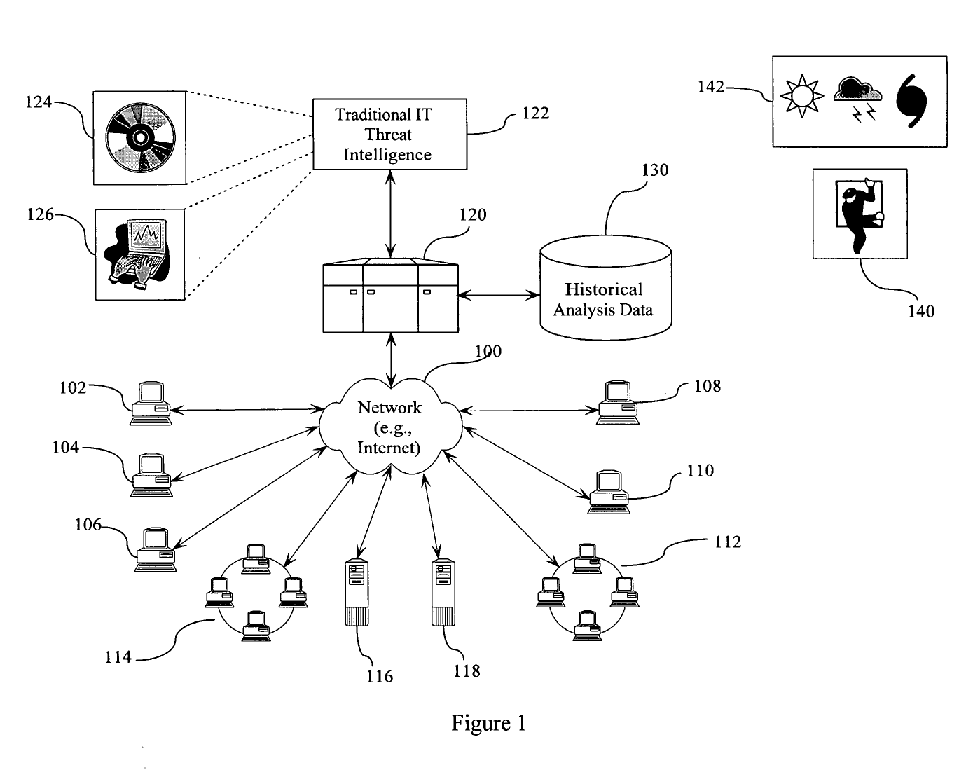

FIG. 1 is a block diagram illustrating a network environment and the various threats to which it is subjected. A network 100 provides interconnectivity between multiple elements, such as individual work stations 102, 104, 106, 108, and 110; local area networks 112 and 114; and servers 116 and 118. Although shown in FIG. 1 as all being connected by a single network connection 100, it is understood that there may be many individual network connections that form the interconnection between the processing elements shown in FIG. 1.

A processor 120 is couplable to the various elements 102-118 via network connection 100. Processor 120 is also coupled to a traditional IT threat intelligence database 122 and a historical analysis database 130.

Traditional IT threat intelligence database 122 stores information gathered regarding “traditional IT threats”. Traditional IT threats include software-related threats such as viruses, illustrated by block 124, and hacker-related attacks, illustrated by block 126. These forms of threats are directed specifically towards the operational IT elements, that is, they are deliberate attacks designed for the sole purpose of disrupting the operation of the IT elements 102-118, and the route of gaining access to the IT elements 102-118 is through internal computer-implemented means, including via networks, hard drives, software code, floppy disks or CDs and other computer-based access means.

Also illustrated in FIG. 1 are more general, non-traditional threats such as a terrorist or other physical attack on system hardware and facilities (illustrated by block 140), and weather-related problems introduced by thunderstorms, severe winds and hurricanes, tornadoes, sunspots and the like (illustrated by block 142). These elements are general in nature and may impact everything in their vicinity, including any network systems that may be in place. They do not require direct internal access to the network, software, hard drives, etc. used by the IT elements 102-118, rather, they will cause damage due to anything in the way, including the networks and/or computers.

For example, the terrorist attacks that occurred at the World Trade Center in New York City in September of 2001 were not directed to network systems but were instead directed at a United States symbol of financial power. Everything in both towers, as well as many other buildings in the area, were completely destroyed. However, as a byproduct of this attack, numerous network systems were also shut down and destroyed, even though they were not the focus of the attack. Similarly, flooding events or other weather-related events will severely impact cities and towns in a very general way, destroying homes, businesses, roadways and other infrastructure of the area of the flood zone; as a side effect, however, network facilities within the flood zone may also be disrupted and/or destroyed. It is these more generic types of threats that are not included in prior art network threat assessment tools. The present invention remedies this situation.

As can be seen in FIG. 1, there is no intelligence regarding the non-traditional threats (in this example, blocks 140 and 142) provided to the processor 120. These non-traditional threats are simply threats affecting the environment generally and not directed solely at internal operations IT systems such as software and operating systems. The prior art does not factor these non-traditional elements into threat analysis and thus they are not analyzed by processor 120.

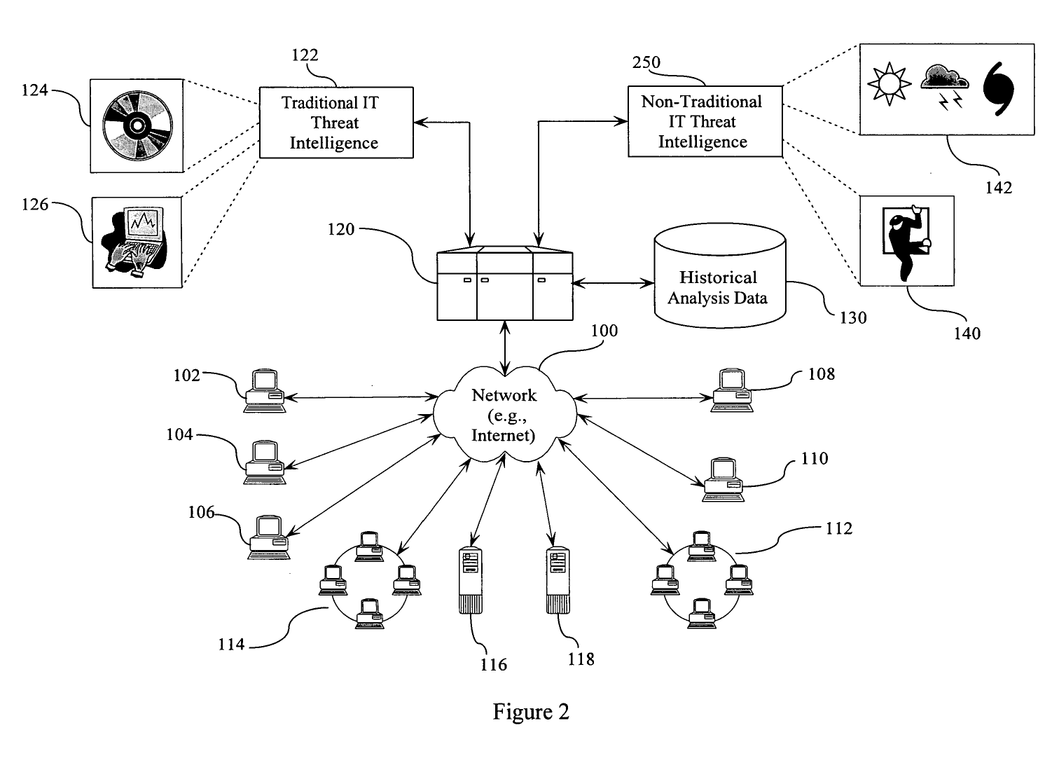

FIG. 2 is a block diagram illustrating a system to practice the method of the present invention. Referring to FIG. 2, non-traditional IT threat intelligence, such as that relating to weather elements 140 and terrorist elements 142, is stored in a non-traditional IT threat intelligence database 250 and is supplied to the processor 120 that performs the traditional IT threat intelligence analysis. As with the prior art system, which utilizes only the traditional IT threat intelligence from traditional IT threat intelligence database 122, the present invention also analyzes non-traditional IT threat intelligence against historical analysis data from the historical analysis database 130. Based on this analysis, the processor 120 supplies threat intelligence to the network. Unlike the prior art, the present invention factors into the threat warnings the impact of non-traditional It threats (e.g., weather, likelihood of terrorist events and the like) so that these factors are included in any threat ratings.

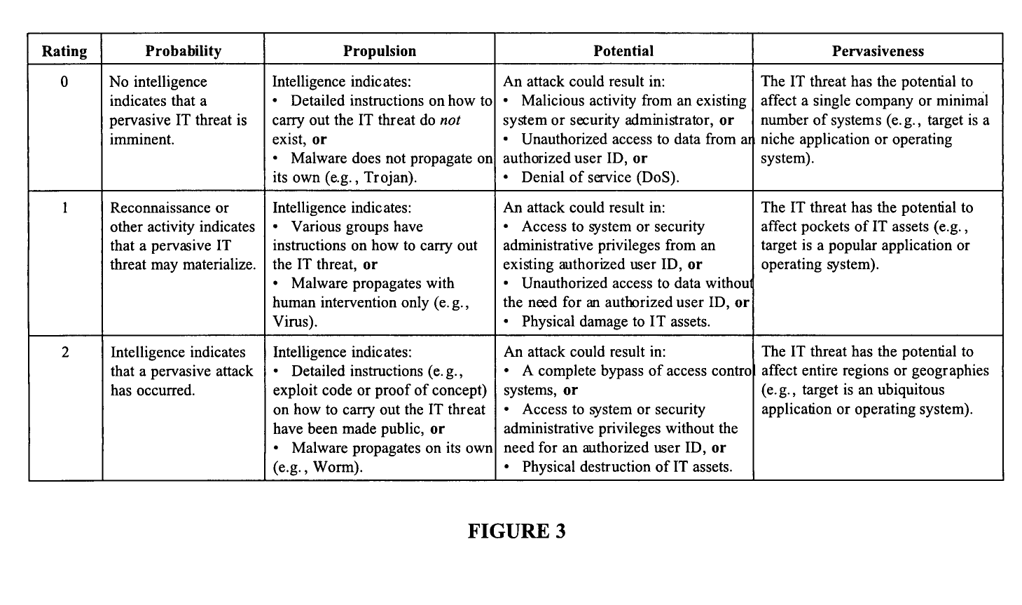

FIG. 3 is an example of a threat matrix used by the processor 120 to develop threat ratings. The threat matrix of the present invention has four categories which are combined to make up an overall threat score. The first factor, “Probability” is an identification of the likelihood, based upon the gathered intelligence, that a threat to the IT environment is going to occur. The second category, “Propulsion”, is a measure of the ease with which a particular threat can be implemented. The third factor, “Potential” is a measure of the likely problems/damage that could result in the event of the occurrence of a particular IT threat. Finally, the last factor, “Pervasiveness”, is a measure of the threat of the threat, that is, how widespread or isolated the potential IT threat could be.

For each of the four factors, three levels of strength are given. The lowest level, “0”, represents the lowest level of concern with respect to each of the four factors. A rating of 0 for the Probability factor indicates that there is no intelligence indicating that a pervasive IT threat is imminent. A rating of 0 for the Propulsion factor means that the intelligence indicates that detailed instructions on how to carry out the IT threat do not exist, or in the case of malware, that is does not propagate on its own such as a Trojan would. A weather event typically is not subject to human control and thus would always be rated “0” for Propulsion. A terrorist threat might include factors that could increase the ease of repeatability, e.g., training manuals, videos, training camps and the like.

A rating of 0 under the factor “Potential” indicates that an attack or IT threat could result in malicious activity from an existing system or security administrator, or unauthorized access to data from an authorized user ID, or denial of service attack, or a shutdown in operations locally. These are all low levels of damage and, while they should be dealt with, do not require the level of response that other more harmful situations could present.

Finally, a rating of 0 under the Pervasiveness factor indicates that the IT threat has the potential to affect only a single company or minimal number of systems (that is, for example, the target (or victim, in the case of a natural disaster) is a niche application or operating system).

A rating of “1” for any of the four factors indicates an increase over the 0-rating conditions. A rating of 1 under Probability indicates that reconnaissance or other intelligence activity indicates that a pervasive IT threat may materialize. A rating of 1 under Propulsion indicates that the intelligence indicates that various groups have instructions on how to carry out the IT threat, or that the malware that is the carrier of the IT threat propagates with human intervention only, such as a virus would operate.

A rating of 1 under Potential indicates that an attack could result in access to the system or security administrative privileges from an existing authorized user ID, or unauthorized access to data without the need for an authorized user ID, or physical damage to IT assets. Finally, a rating of 1 under Pervasiveness indicates that the IT threat has the potential to affect pockets of IT assets (e.g., the target is a popular application or operating system).

Finally, a rating of “2” indicates, under Probability, that the intelligence indicates that a pervasive attack or event (e.g., a hurricane) has already occurred. A rating of 2 under Propulsion indicates that the intelligence has indicated that detailed instructions (e.g., exploited code or proof of concept) on how to carry out the IT threat have been made public, or that the malware propagates on its own (e.g., such as a worm).

A rating of 2 under Potential indicates that an attack could result in a complete bypass of access control systems, or access to system or security administrative privileges without the need for an authorized user ID, or physical destruction of IT assets. Finally, a rating of 2 under Pervasiveness indicates that the IT threat has the potential to affect entire regions or geographies (e.g., the target is a ubiquitous application or operating system.

The system according to the present invention operates as follows. First, for a particular IT threat (traditional or non-traditional), a rating is given for each of the four factors. Next, the rating values are added together (overall threat score=probability score+propulsion score+potential score+pervasiveness score). The result of this calculation is the overall threat score, a value from 0 to 8. Obviously a rating of 0 indicates the lowest level of threat and a rating of 8 represents the highest level threat. Values in between give network operators and other interested persons a good overall view of how likely or unlikely threats are likely to result in network problems, in view of the conditions at the time the threat analysis was made.

Better results may be achieved by weighting the scores based upon their relative contribution to a particular threat. For example, as described above, for a particular IT threat, a rating can be given for each of the four factors. Next, the rating values can be multiplied by a weight factor. For example, both the Probability and Propulsion categories can have a 0.2 weighting. Potential can be given a weighting of 0.1, and Pervasiveness, being the biggest contributing factor in this example, can be weighted at 0.5. This weighting ensures that those threats that could affect the largest number of targets and/or that seem the most likely to occur are rated higher. The result of this calculation is the overall threat score, a value from 0 to 2.

Using several ranges of values, this threat score is then assigned a rating of 0 to 10. A score of 0 indicates the lowest level of threat and a rating of 10 represents the highest level of threats. Values in between give network operators and other interested persons a good overall view of how likely or unlikely threats could result in network problems, in view of the conditions at the time the threat analysis was made.

Numerous sources are available from which to gather the non-traditional IT threat information. Human analysts can review world news and world events to indicate the likelihood of terrorism occurring at a particular area. For example, during a political convention in New York, the likelihood of a terrorist event occurring may be heightened and thus this information can be stored in the non-traditional IT threat intelligence database for use in the threat analysis. Similarly, weather data is readily available for the entire world. To the extent that particular weather data may impact a particular network site, this information can also be factored into the decision. Numerous other factors can be utilized in making the threat analysis described herein. It is not the specific types of non-traditional data utilized for the threat analysis that is novel but, instead, it is the use of non-traditional threat data at all that is novel.

A further aspect of the present invention introduces the daily decayed threat score (DDTS). As noted above, an organization receiving the general threat analysis will utilize the information to, if appropriate or necessary, minimize the impact of an actual occurrence or minimize the potential impact of a threat. Accordingly, in view of these corrective measures, the threat will in most cases, be reduced upon the taking of these measures. In other words, the threat decays over time in a typical situation.

The decayed threat scores indicates the nature of an ongoing threat's impact to an organization over time due to several factors. These factors may include (but are not limited to) the application of vendor-supplied patches, the attrition of available hosts due to compromise and subsequent repair of the host, or even the diminishment of physical threats due to disaster recovery plans.

In accordance with this aspect of the present invention, each day a DDTS is calculated for every threat reported in the system since it went into service. All DDST's are summed, and a baseline is established by taking that sum and dividing it by the total number of reporting days. The resulting average is the daily IT ambient. The daily IT ambient gives an organization a “feel” for the number of threats and the likelihood that the reported threats could impact the organization.

Calculation of the threat ambient is as follows: a baseline ambient score is calculated by taking the decayed daily score of all dates in the time frame that were scored.

A decayed daily score (designated DDS for brevity) is calculated with the following equations:

s—daily threat score calculated as the sum of threats reported on that day;

n—number of calendar days elapsed since the threat was originally reported;

r—rate of threat score impact decay;

$$S - denotes the DDS$$

$$x = s - nr$$

$$S = \{ \begin{matrix}x \geq 0 , x \\ x < 0 , 0\end{matrix} \}$$

The baseline decayed ambient (designated BDA) is calculated with the following equations:

S—denotes the DDS;

N—number of report days which fall within the previously used n days;

A—denotes the BDA.

$$A = \frac{\sum S}{N}$$

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage of a device on which an IM client is running. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A method of rating a threat to the proper operation of an Information Technology (IT) system operated by an individual or organization, comprising the steps of:
collecting intelligence regarding non-traditional IT threats to said IT system;
developing an overall threat score for each non-traditional IT threat that defines the overall potential for the non-traditional threat to do harm; and
distributing said overall threat score to said individual or organization.

2. The method of claim 1, wherein said developing step includes the steps of:
scoring each threat according to one or more predetermined characteristics, using a predetermined ratings scale for each characteristic; and
combining, according to a formula, said scoring of each of said characteristics into said overall threat score.

3. The method of claim 2, wherein said predetermined characteristics include one or more of the following: probability, propulsion, potential, pervasiveness.

4. The method of claim 2, wherein said predetermined characteristics include all of the following: probability, propulsion, potential, pervasiveness.

5. The method of claim 1, further comprising the steps of:
collecting intelligence regarding traditional IT threats to said IT system;
developing an overall threat score for each traditional IT threat that defines the overall potential for the traditional threat to do harm; and
distributing said overall threat score to said individual or organization.

6. The method of claim 1, further comprising the step of:
developing a decayed threat score for each overall threat score; and
distributing said decayed threat score to said individual or organization.

7. The method of claim 6, wherein said decayed threat score is developed and distributed on a daily basis.

8. A system of rating a threat to the proper operation of an Information Technology (IT) system operated by an individual or organization, comprising:
means for collecting intelligence regarding non-traditional IT threats to said IT system;
means for developing an overall threat score for each non-traditional IT threat that defines the overall potential for the non-traditional threat to do harm; and
means for distributing said overall threat score to said individual or organization.

9. The system of claim 8, wherein said means for developing includes:
means for scoring each threat according to one or more predetermined characteristics, using a predetermined ratings scale for each characteristic; and
means for combining, according to a formula, said scoring of each of said characteristics into said overall threat score.

10. The system of claim 9, wherein said predetermined characteristics include one or more of the following: probability, propulsion, potential, pervasiveness.

11. The system of claim 9, wherein said predetermined characteristics include all of the following: probability, propulsion, potential, pervasiveness.

12. The system of claim 8, further comprising:
means for collecting intelligence regarding traditional IT threats to said IT system;
means for developing an overall threat score for each traditional IT threat that defines the overall potential for the traditional threat to do harm; and
means for distributing said overall threat score to said individual or organization.

13. The system of claim 8, further comprising:
means for developing a decayed threat score for each overall threat score; and
means for distributing said decayed threat score to said individual or organization.

14. The system of claim 13, wherein said decayed threat score is developed and distributed on a daily basis.

15. A computer program product for rating a threat to the proper operation of an Information Technology (IT) system operated by an individual or organization, the computer program product comprising a computer-readable storage medium having computer-readable program code embodied in the medium, the computer-readable program code comprising:
computer-readable program code that collects intelligence regarding non-traditional IT threats to said IT system;
computer-readable program code that develops an overall threat score for each non-traditional IT threat that defines the overall potential for the non-traditional threat to do harm; and
computer-readable program code that distributes said overall threat score to said individual or organization.

16. The computer program product of claim 15, wherein said developing step includes:
computer-readable program code that scores each threat according to one or more predetermined characteristics, using a predetermined ratings scale for each characteristic; and
computer-readable program code that combines, according to a formula, said scoring of each of said characteristics into said overall threat score.

17. The computer program product of claim 16, wherein said predetermined characteristics include one or more of the following: probability, propulsion, potential, pervasiveness.

18. The computer program product of claim 16, wherein said predetermined characteristics include all of the following: probability, propulsion, potential, pervasiveness.

19. The computer program product of claim 15, further comprising:
computer-readable program code that collects intelligence regarding-traditional IT threats to said IT system;
computer-readable program code that develops an overall threat score for each traditional IT threat that defines the overall potential for the traditional threat to do harm; and
computer-readable program code that distributes said overall threat score to said individual or organization.

20. The computer program product of claim 15, further comprising:
computer-readable program code that develops a decayed threat score for each overall threat score; and
computer-readable program code that distributes said decayed threat score to said individual or organization.

21. The computer program product of claim 20, wherein said decayed threat score is developed and distributed on a daily basis.
